(19) United States
(12) Patent Application Publication
(10) Pub. No.: US 2025/0388002 A1
(43) Pub. Date: Dec. 25, 2025

(54) LIGHTING VEHICLE GLAZING

(71) Applicant: AGC GLASS EUROPE, Louvain-la-Neuve (BE)

(72) Inventors: Héloïse ROELANDTS, Gosselies (BE); Jean-François NOULET, Gosselies (BE)

(73) Assignee: AGC GLASS EUROPE, Louvain-la-Neuve (BE)

(21) Appl. No.: 18/880,426

(22) PCT Filed: Jul. 19, 2023
(86) PCT No.: PCT/EP2023/070070

§ 371 Date: Dec. 31, 2024

(30) Foreign Application Priority Data
Jul. 19, 2022 (EP) 22185766.7

(51) Int. Cl. B32B 17/10; B32B 7/12; B60Q 3/208; B60Q 3/64

(52) U.S. Cl. CPC B32B 17/10036; B32B 7/12; B32B 17/10449; B32B 17/10541; B60Q 3/208; B60Q 3/64; B32B 2307/418; B32B 2605/08

(57) ABSTRACT

The present invention relates to a lighting vehicle glazing comprising (i) an external glass pane (11), (ii) an Internal glass pane (12) acting as a light guide layer, (iii) the first and the second glass panes (11, 12) being laminated together via at least a first plastic interlayer (14), (iv) a light-decoupling means (13) provided between the first plastic interlayer and the internal glass pane (12), (v) a masking band provided along the periphery of the inner surface (P2) of the external glass pane and/or the inner surface (P4) of the internal glass pane, (vi) a light source (20) provided on the masking band or in the vicinity of the masking band, the light source being placed on the inner surface (P4) of the inner glass pane (12). According to the invention, at least one coupling element (30) is provided in the vicinity of the light source in a free zone of masking band, and materially bonded to the internal glass pane (11) on its inner surface (P4), that couples the light emitted from the light source (20) into the internal glass pane, the light source (30) facing a side edge (310) of the coupling element.

### FIELD OF THE INVENTION

The present invention relates to an lighting glazing unit for vehicles, particularly a lighting glazing forming part of the roof of a motor vehicle. Such a vehicle window is known from practice and can be used in particular in the field of a vehicle roof.

### BACKGROUND OF THE INVENTION

It is known from prior art lighting vehicle glazing with a glass pane acts as a light guide layer. It is also known roof glazed provided with a light source coupled to the light guide layer. For safety of passengers of the vehicle, the glazing is a laminated glazing provided with an external and an internal glass pane. It is well known that a coupling element is provided on an edge of the internal glass pane acting as a light guide layer. The internal glass pane is thus generally smaller than the outer glass pane in order to have sufficient space to fix the coupling element against the edge of the internal glass pane. Thus, light emitted by the light source can be coupled through the edge of the light guide layer.

It is also known from EP3463869, glazing with holes into which the light source is provided making the glazing difficult to produce.

It is also known from WO2021198262 to use a plastic coupling on the inner face of the roof. The coupling element described in WO'262 has a trapezoidal shape. Plastic material is often used for coupling element because it is easy to shape in the required shape and more particularly in complex shape in order to play the role of light guide. However, the coefficient of thermal expansion and the refractive index of plastic is different from the coefficient of thermal expansion and refractive index of the glass leading to a loss of light emitted by the light source through the glazing and also affecting stability of the lighting glazing. Another issue with the plastic coupling is that the aging of the plastic material is beyond than the glass, this one may lead to a decrease in the brightness or a color shift and eventually the plastic coupling element needs to be changed.

### DESCRIPTION OF THE INVENTION

It is an object of the present invention to provide a lighting laminated glazing and more particularly a laminated glazed roof more simple to produce and with good aesthetic. The invention proposes also proposes a method to produce such a glazed laminated glazing.

According to the invention, this object is achieved by a lighting vehicle glazing comprising (i) an external glass pane, (ii) an internal glass pane acting as a light guide layer, (iii) the first and the second glass panes being laminated together via at least a first plastic interlayer, (iv) a light-decoupling means provided between the first plastic interlayer and the internal glass pane, (v) a masking band provided along the periphery of the inner surface (P2) of the external glass pane and/or the inner surface (P4) of the internal glass pane, (vi) a light source provided on the masking band or in the vicinity of the masking band, the light source being placed on the inner surface (P4) of the inner glass pane.

According to the invention, at least one coupling element is provided in the vicinity of the light source in a free zone of masking band, and materially bonded to the internal glass pane (on its inner surface (P4), that couples the light emitted from the light source (into the internal glass pane), the light source facing a side edge of the coupling element, the coupling element being made of glass.

According to the invention, a vehicle glazing is thus proposed in which the light emitted by the light source can be coupled into the light guide layer over a large area, specifically by means of the coupling element arranged on the inner surface of the glazing.

According to the proposed invention, this makes it possible to optimally adapt the light guide layer to the requirements in terms of its dimensions of the glazing (large areas) or its base area. In addition, only light with certain angles of incidence is coupled into the internal glass pane acting as a light guide layer. Preferably, in order to remain in total internal reflection (TIR) in the internal glass pane, the angle of incidence of light is equal to or below 14° (0° being the glass plane), depending on the added layers/coatings onto the glazing, the incident angle may go up to 30°. Light rays that are outside of this range are not coupled in, so they do not propagate in the internal glass pane since the light will not remain in in TIR. This improves the luminance and also the luminance homogeneity over the surface of the internal glass pane. The coupling element provided on the inner face (P4) of the internal glass pane thus directs the light emitted by the light source into the light guide layer at defined angles, with the result that a higher in-coupling efficiency is achieved, the coupling efficiency should be understood as the efficiency of light coupled into and enabled to propagate in the glass sheet with TIR, i.e., the light coupled to the inner glass pane but not being able to propagate in TIR condition is counted as loss.

According to the present invention, the coupling element may be arranged onto the inner face of the internal glass pane in case of glazing is a laminated glazing or onto the inner face of the glazing in case of the glazing is a toughened safety glass and laminated safety glass.

According to the present invention, the glazing is a laminated safety glass. The glazing comprises an external pane and an internal pane, laminated together thanks to an interlayer and more particularly a thermoplastic interlayer.

According to the present invention, the internal glass pane acts as a light guide layer. Therefore the need for a light guide layer to enlighten the glazing is then resolved by being able to use the internal glass pane as the light guide layer.

As commonly used, a masking band also called a black band, generally made of enamel is provided along the periphery of the inner face (P2) of the external glass pane and/or the inner face (P4) of the internal glass pane.

According to the present invention, a light source is provided onto the inner face of the internal glass pane. The light source is preferably provided in the vicinity of the edge of the masking band. The light source is preferably not deployed on the black band.

According to the present invention, the coupling element can be attached directly to the inner face of the internal glass pane. The coupling element is preferably coupled to the light source. Thus, the coupling element is provided in the vicinity of the light source and is preferably in contact with it (direct contact or not) to be able to couple the light coming out from the light source to the coupling element.

In a particular embodiment, in the case of laminated safety glass, an additional light guide layer is applied to the internal glass pane, into which the light from the light source can be coupled by means of the coupling element.

One of the advantages of the present invention is that the coupling element can be easily arranged on the inner face of the internal glass pane without relevant additional cost. Indeed, the coupling element can be attached to the glazing after its assembly avoiding any modification in the shape, bending, optical distortion of the glazing. Moreover, it is also possible to attach the coupling element before bending. It should be understood that since the coupling element is also made of glass material as the glazing itself, it is more convenient to produce the glazing with the coupling element of the present invention. The internal glass may thus have the same dimensions than the external glass pane. Also, the invention allows more potential for combination with other options like glazing combining lighting and switchable function (as with PDLC), with photovoltaic cells easier to produce than the standard glazed roof.

Furthermore, the limitation due to the place or installation space is reduced since the coupling is provided on the one inner face of the glazing and not in an edge of the internal glass pane or a hole or a notch provided in the internal glass pane for the integration of the light source. Furthermore, the coupling element (and the light source) is placed in a dry zone of the car where it is protected from moisture or water.

According to the an embodiment of the present invention, the internal glass pane is preferably made of a glass material.

The interlayer used to laminate the internal and external glass panes is preferably formed from a material that includes PVB, EVA and/or TPU. The interlayer can be clear or transparent or colored.

In a preferred embodiment of the present invention, the coupling element of the vehicle window according to the invention is designed like a strip and is preferably arranged near the edge on the of the inner face of the internal glass pane in an area free of masking band. The coupling element is coupled to the light source. Light is then be coupled into the internal glass pane thanks to the extension of the strip-like coupling element. In a special embodiment of the vehicle glazing according to the invention, a plurality of coupling elements of the type described above are provided, which can be arranged close to the edges on opposite edges of the pane body arrangement.

According to the present invention, the coupling element is made of glass material. The shape or dimension of the coupling element is designed to be able to optimize the coupling angle of the light that is coupled into the internal glass pane acting as a light guide layer. The advantage of a glass coupling element is that it is easily produced from a glass pane. Thus, the production of lighting glazing according to the present invention is less cost to produce and yet with more than adequate coupling efficiency.

The thickness and width of the coupling element should be selected carefully to maximize the coupling efficiency of rays that will be able to stay in TIR in the second glass pane.

The thickness should be kept as small as possible knowing that practically it is limited be the size of the light source. In practice, a thickness equal or lower than two times the thickness of the second glass can be considered as efficient.

The width will be optimized to allow the maximum of light to propagate directly towards the internal glass pane acting as light guide and to allow a part of the light to bounce on the inner surface of the coupling element and then to be coupled in TIR into the internal glass pane.

The coupling element has preferably a flat-shaped cross section according to the invention. Thus, the coupling element may be easily produced.

The coupling element thus acts in the manner of an optical prism.

According to the present invention, the coupling element is made of glass. The refractive index of the coupling element is in particular adapted to the refractive index of the internal glass pane acting as a light guide layer and preferably has a value between 1.40 and 1.65 and in particular between 1.48 and 1.59. In the description, the term “refractive index” may be shortened with the symbol “nX” or “NX”.

According to a preferred embodiment of the present invention, the composition of the coupling element is the same or similar to the composition of the internal glass pane. In a preferred embodiment, the refractive index of the coupling element is equal to or higher that the refractive index of the internal glass pane.

In order to improve the internal reflection, the coupling element can be provided with a reflective coating, which can include metals such as aluminum or silver and can be applied after a vapor deposition or sputtering process.

According to another embodiment of the present invention, the edges of the coupling element are grinded with a polished surface finish, to increase visible light transmission. The edges may also be ground to a convex, concave or other contour to help to focus the light inboard of the edge. In a preferred embodiment, the edges of at least the notch are ground to a flat profile (simple chamfer) and polished to facilitate the entry of light in the internal glass pane from the light source. The edge is then more optically transparent to the light from the light source.

The coupling element is preferably attached to the inner face (P4) of the internal glass pane thanks to an adhesive layer.

The adhesive layer, which preferably has a refractive index between 1.405 and 1.657 and more preferably between 1.48 and 1.567, can be formed from any optically suitable adhesive. More preferably, the refractive index of the adhesive layer is comprised between 1.51 (refractive index of the glass pane) and 1.6 in order to minimize losses by reflection. The adhesive layer has a refractive index at least higher than the refractive index of the interlayer used to laminate the external and internal glass panes.

For example, the adhesive layer is made of a pressure-sensitive adhesive, an optically clear liquid adhesive (LOCA), ethylene vinyl acetate (EVA), polyvinyl butyral (PVB), thermoplastic polyurethane TPU (TPU), an epoxy adhesive or an acrylic based adhesive. More preferably, the adhesive layer is an optical glue. The adhesive layer is transparent to the wavelengths used.

The selected materials preferably have refractive indexes that minimize refraction of the light rays at the interfaces and optimize the coupling efficiency under the ideal angular conditions.

The refractive indexes of the inner pane made of glass is in particular of 1.510, whereas the refractive indexes of the coupling element and the adhesive, by means of which the coupling element is connected to the inner pane, can vary depending on the material selected. The coupling element has then a refractive index equal to or higher than the refractive index of the internal glass sheet. The refractive index of the adhesive layer equal to or higher than the refractive index of the coupling element.

According to one embodiment of the present invention, the coupling element has preferably a flat surface facing the light surface in order to focus the light. The light is then injected into the coupling element through its flat surface.

According to another embodiment, the edge of the coupling element may be curved to optimize the direction of the light. The coupling element may have a curvature fitting with the curvature of the glazing.

Areas/surfaces of the coupling element can also be provided with a reflective coating.

In an alternative embodiment of the vehicle window according to the invention, the light source is arranged directly on a side surface of the coupling element.

For example, the light source, which is designed in particular as a high-performance LED module, is an LED bar or an LED strip with a large number of LEDs, which emit their light directly into the coupling element.

According to an embodiment of the present invention, a plurality of light source is provided along the periphery of the glazing. Further, the light source may be provided on one side of opposing sides or two sets of opposing sides of the glazing.

In another embodiment, the light source is optical fibers to transmit light, a waveguide combined with LEDs or laser diodes.

According to one embodiment of the present invention, on the coupling element, a tape, mirror coating, or reflective paint may be provided on the surface opposite the entrance of the light to optimize the coupling of light in the glazing and more particularly in the roof. Thus, loss of light is reduced.

Furthermore, a cladding element or a cover can be arranged on the inner face of the internal glass pane which conceals the coupling element and the light source.

The cover forming a housing may be bonded to the glazing.

According to another embodiment, the light source and the coupling element may be encapsulated onto the inner face of the internal glass pane and/or the edge of the glazing. The encapsulation means may be an element prepared by injection molding or may be a preformed bead, such as a bead of adhesive or elastomer, applied and fixed at the border of the glazing unit, on the first main face of the first sheet and also, if necessary, on the first main face of the second sheet if the geometry of the border of the glazing unit is suitable for this.

The light source may be fixed onto the side edge of the coupling element by means of a resin or an optical glue. Thus, the light source and in particular the LEDs and its associated electronic components fixed to a printed circuit board are fixed onto the inner face of the internal glass pane and/or edge of the glazing with a polymeric material such as silicon, epoxy, polyurethane. Thanks to the optical resin, the beam shape from the light source may be adapted. Thus, the light source is protected from moisture while the right transparent level to allow the right light injection into the glass is maintained.

Due to the special arrangement of the light source and the coupling element on the inner surface of the internal glass pane of the glazing, the light source, which is formed from LEDs, for example, is also subjected to less thermal stress than when it is laminated into the glazing. Furthermore, the light source is less in contact with the interlayer leading to less chemical interactions between the light source and the interlayer (lifetime of light source increased). In addition, the light source can be replaced easily, so that destruction of the composite between pane and light-conducting layer does not occur.

According to an embodiment of the present invention, a light-decoupling means may be provided between the interlayer used to laminate the internal glass pane with the external glass pane, and the internal glass pane. The light-decoupling means may be a textured inner surface of the internal glass pane. The textured face of the internal glass pane may be obtained by texturing the inner surface (P3) of the internal glass pane. The texturing may be also obtained by applying a paint on the inner surface of the internal glass pane. The texturing may be also obtained by laser structuring of the surface, which acts as the decoupling means for the light, so that a light exit of laterally coupled-in light is preferably caused via the lower main surface. All those technics of texturing are well-known for skilled man in the art.

According to an embodiment of the present invention, the light-decoupling means may be a light-decoupling interlayer that could be laminated into the glazing. The light-decoupling layer has structuring of the surface, which acts as the decoupling means for the light, so that a light exit of laterally coupled-in light is preferably caused via the lower main surface. The structuring is provided in this case in particular on the inner face of the layer facing toward internal glass pane.

The subject of the invention is also a vehicle roof comprising a vehicle glazing of the type described above.

The present invention relates also to the use of a coupling element having a parallelepiped shape to couple a light emitted from the light source into the internal glass pane acting as a light guide of a laminated glazing, the light source facing a side edge of the coupling element and the coupling element and the light source being placed on the inner surface P4 of the internal glass pane. One another object of the present invention is to provide a coupling element with a simplified shape that whatever the material of the coupling element, the production of the coupling element is eased comparing to the complex shaped coupling elements used in the prior art.

In a preferred embodiment, the coupling element has a rectangular-like shape. Thus, a simple shape may be used to couple light and to produce a laminated glazing with an uniform lighting over the area of the glazing.

In a preferred embodiment, the coupling element is made of glass. Thus, the coupling element will have a refractive index close to the refractive index of the glass pane used to form the glazing. Furthermore, the coupling element may be cut from the mother pane used to form the glass pane forming the glazing, thereby simplifying the manufacture process, reducing costs while keeping the better performance.

The present invention also covers a method to produce a laminated as described in the present invention. The method comprises the following steps:
a. Provide an external glass pane having an outer and an inner surface
b. Provide an internal glass pane having an outer and an inner surface
c. Provide a light decoupling means between the external and the internal glass pane
d. Laminate the external and the internal glass panes with an interlayer
e. Provide a coupling element and a light source onto a part of the inner surface of the internal glass pane, the coupling element being glass and having a parallelepiped-like shape.

The coupling element is as described in the description.

Further advantages and advantageous configurations of the subject matter of the invention can be found in the description, the drawing and the claims.

Embodiments of a glazing and more particularly a vehicle roof with a vehicle window according to the inventions are shown in simplified form in the drawing and are explained in more detail in the following description. Thus,

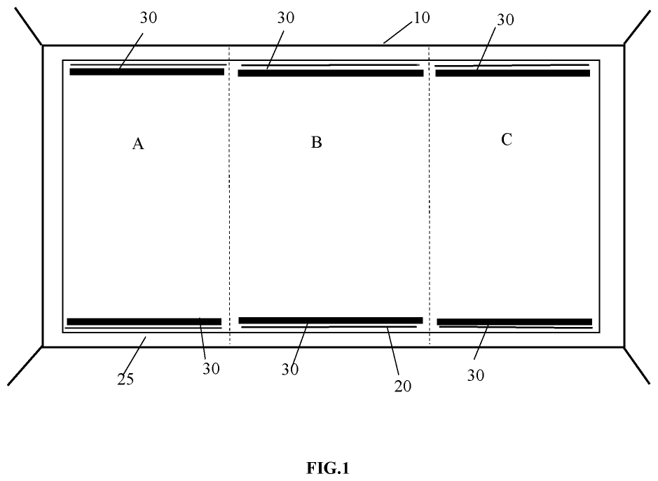

FIG. 1 shows a schematic top plan view of a vehicle roof with a coupling element according to the invention;

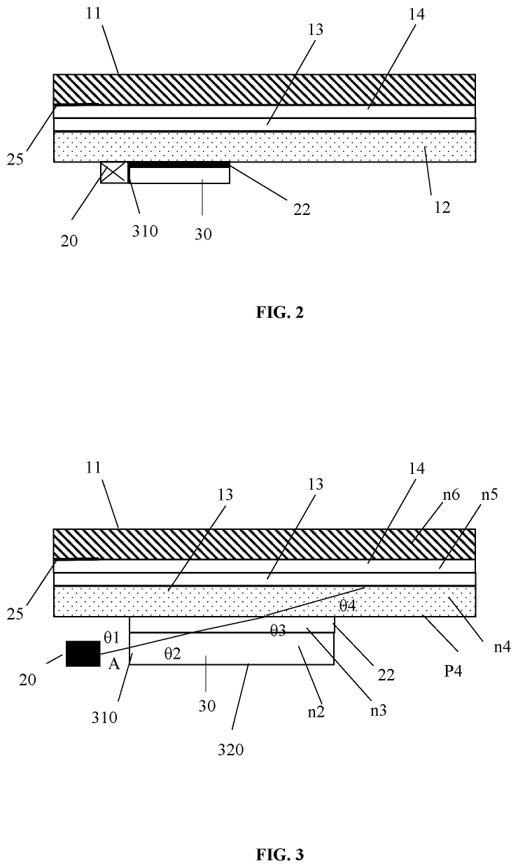

FIG. 2 shows a schematic section through the vehicle glazing of the vehicle roof according to FIG. 1;

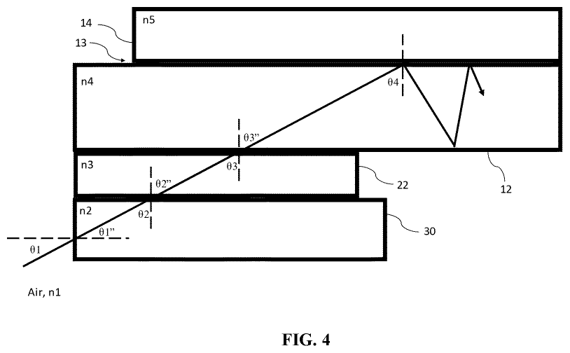

FIG. 3 shows a cross-sectional view for explaining the optical properties of the laminated glass for a vehicle according to the invention and corresponding to FIG. 2 and FIG. 4 shows more detailed explanation for the light propagation.

FIG. 1 shows a vehicle roof 10 of a motor vehicle which is otherwise not shown in detail.

The vehicle roof 10 is a fixed glazing panoramic roof divided in this example into three areas (A, B, C) wherein at least one light source 20 and the coupling element 30 will be arranged. The roof 10 is intended to be fixed to the car body into an opening.

The glazed roof 10 is implemented, for example, as a laminated vehicle glazing. The glazing unit according to the invention is preferably mounted on the vehicle in such a way that the internal glass pane is the one in contact with the passenger compartment of the vehicle and the external glass pane is the one located nearer the outside of the vehicle, commonly in direct contact with the atmosphere outside the vehicle.

A masking band 25 along the periphery of the glazing is provided to protect and to hide unesthetic element as glue, the fixation means . . . fixed on the glazing. The black band is well known for skilled man in the art. The black band, generally an enamel, may be provided at the periphery of the inner face P2 of the external glass pane 11 and/or the outer face P4 of the internal glass pane 12.

The internal glass pane 12 may be a clear glass or more preferably the internal glass pane 12 may be an extra-clear glass.

This structure is shown in more detail in FIG. 2.

In this particular embodiment, a light-decoupling layer 13 is provided between the external and the internal glass panes 11, 12 and configured in particular in this case to decouple light coupled in at the end side in the longitudinal direction through the layer. Furthermore, the light-decoupling layer 13 has structuring of the surface, which acts as the decoupling means for the light, so that a light exit of laterally coupled-in light is preferably caused via the lower main surface, i.e., by the light decoupling layer 13, it is aimed that a portion of light coupled into the internal glass pane 12 propagating in TIR condition to decouple and exit from glass pane 12 towards passenger compartment, i.e., inside of the vehicle, thereby providing an illuminated glazing. The structuring is provided in this case in particular on the inner face of the layer 13 facing toward the internal glass pane 12.

The decoupling is based on the effect that light is refracted or scattered on the structuring 13 and is therefore emitted at an angle which enables an exit from the surface of the layer 12. Without the structuring, the coupled-in light is typically incident at such a flat angle on the surface of the layer 12 that total reflection of the light occurs.

The structuring 13 of the surface of the layer 12 is produced mechanically, for example, by imprinting the structure into the surface. Alternatively, the structuring can be caused by printing, in particular using a pad print, so that the printed material represents the scattering structures. A further possibility for the structuring of the surface of the layer 12 consists of etching of the surface, by which the surface is roughened to generate the scattering effect. Furthermore, the roughening or structuring can also be achieved by a blasting method, for example, by sandblasting.

The external glass pane 11 and the internal glass pane 12 are laminated together with an interlayer 14.

A thermoplastic interlayer 14 is provided between the inner face (P2) of the external glass pane 11 and the light-decoupling layer 13 to laminated the external and the internal glass pane. The interlayer 14 can have multiple functions. On the one hand, it can be used as a lamination layer, which causes a permanent bond between the pane 11 and the glass pane 12. In addition, the interlayer 14 can be implemented as a refractive layer, which in particular has a lower index of refraction than the light-decoupling layer. Light incident on the interface between the layer 13 and the layer 14 thus remains in the light-decoupling layer 13 and does not pass into the internal pane 12 (nor external pane 11). Light absorption in the pane 11 or light exit from the vehicle into the surroundings is avoided in this way. The interlayer 14 is in a preferred embodiment a grey or colored PVB. The thickness of the PVB may the standard one as about 0.75 mm-0.8 mm. However, the thickness may be lower than 0.75 mm. In another embodiment, several thinner interlayer 14 may be superposed. The use of a grey PVB has the advantage of absorbing the light of the structuring 13 to concentrate the light inside the glazing and/or to decrease eventually a double image generated by the structuring 13 onto the external glass pane. It is particularly useful when the glazing is provided with IR-reflective coatings, . . . .

Additionally, the interlayer 14 can exercise the function of a splinter protection layer or splinter protection film. For example, the layer 14 is implemented for this purpose from polyvinyl butyral (PVB).

The interlayer 14 is preferably provided so that it acts both as a lamination layer and also as a refractive layer, and furthermore simultaneously as a splinter protection film. Alternatively, the three functions can also be realized by a corresponding layer structure of multiple films. The interlayer extends over the surface of the glass panes 11, 12. Thus, laminated glazing including at least one light source which is provided with surface lighting with an improved uniformity. Another objective of at least some embodiments is to provide such a surface lighting panel which provides a more uniformly diffused surface lighting.

According to an embodiment of the present invention, at least one coupling element 30 is fixed on the inner face (P4) of the internal glass pane 12. Preferably, a plurality of coupling element 30 are provided along the lateral edges of the glass pane 12. The coupling element 30 is made of glass, i.e., glass material similar to glass used in vehicle glazings. Advantageously, the coupling element has the same or close refractive index than the refractive index of the internal glass pane 12. The refractive index may be higher than the refractive index of the refractive index of the internal glass pane 12.

Preferably, the refractive indices of the coupling element is comprised between 1.48 and 1.59.

According to an embodiment of the present invention, the coupling element 30 has preferably a flat shape. However, the coupling element may be curved to fit with the curvature of the roof. Preferably, the coupling element has a rectangular shape. The width, the length and height should be adapted accordingly to the light source and the type of glass used to made the coupling element. The dimensions of the coupling element 30 should be adapted according to the car manufacturer specifications and the type of light source used in order to reach an uniform ambient lighting over the surface of the glazing and more particularly over the surface of the glazed roof.

Preferably, the height is the same or similar to the height of the internal glass pane 12 acting as a light guide, and more preferably less than the thickness of the internal pane 12, thickness and the height are used interchangeably in this context.

Preferably, the coupling element 30 is provided along at least a part of the lateral ledges of the glazing 10 as shown in FIG. 1. It is understood that the coupling element and associated light source may be provided on the right or left side of the glazing to fit with the ambiance lighting required, but not limited to, the light source may also be provided on the front or back side of the glazing 10.

Preferably, the glass composition of the coupling element 30 is similar to the composition of the glass composition of the internal glass pane 12. In a preferred embodiment, the coupling element is made of extra-clear glass to have less absorption of the light and then less loss. The coupling element may be made of a glass with weak absorption. It can potentially be more absorbent than the internal glass pane because the path of light in the coupling element is very short compared to the path in the inner glass.

According to the present invention, the coupling element 30 is arranged in the vicinity of the masking band 25 in a zone free of masking band to minimize the absorption losses of the masking band. The term “vicinity” should be understood as close to the masking band 25 and the distance between the two is less than 20 cm, more preferably less than 10 cm in this context.

According to an embodiment of the present invention, a light source 20 is provided in a manner that the light is emitted preferably perpendicularly to the flat edge 310 of the glass coupling element 30. The edge of the coupling element may be curved. Thus, the light emitted by the light source 20, once activated, is coupled into the coupling element 30.

Preferably, the light source 20 and the coupling element 30 are placed in the vicinity of the masking band in a free zone of masking band. In an embodiment, only the coupling element is in a free zone of masking band. As mentioned above, the term “vicinity” in this embodiment should be understood same as above context.

The light source 20 is preferably one or more modules including light-emitting diodes (LEDs), each including a plurality of light-emitting diodes and associated electronic components fixed to a printed circuit board, the modules being positioned such that emitting faces of the LEDs are turned toward the edge of the first glass coupling element 30. The light source 20 may be top emitting LEDs or side emitting LEDs depending on the intended applications since the coupling element 30 allows both configurations.

The light source may be fixed onto the edge of the glazing by means of a resin or an optical glue. Thus, the light source and in particular the LEDs and its associated electronic components fixed to a printed circuit board are fixed onto the edge of the glazing with a polymeric material such as silicon, epoxy, polyurethane. Thanks to the optical resin, the beam shape from the light source may be adapted. Thus, the light source is protected from moisture while the right transparent level to allow the right light injection into the glass is maintained.

The light source 20 may be enclosed in a housing to fixed the light source on the glazing and also to protect it from external influences. The light source 20 may be encapsulated onto the edge of the glazing and/or the edge of the coupling element. The encapsulation means may be an element prepared by injection molding or may be a preformed bead, such as a bead of adhesive or elastomer, applied and fixed at the border of the glazing unit, on the first main face of the first sheet and also, if necessary, on the first main face of the second sheet if the geometry of the border of the glazing unit is suitable for this.

The LEDs may be side emitting LEDs or top emitting LEDs. Side emitting LEDs form a preferred embodiment. With side LEDs, the LEDs may be more easily placed perpendicularly to the plane of the coupling element 30 for a good coupling inside the coupling element 30 and the internal glass pane 12.

In another embodiment, the light source 20, may be waveguides coupled with LEDs or diode laser or optical fibers.

In a particular embodiment, the light-source 20 and in particular, the LEDs modules, is placed along at least a part of the lateral edges 310 of the coupling element 30. The LEDs modules are then fixed on the glazing 10 for example by encapsulation means.

According to an embodiment of the present invention, a light guide may be provided between the coupling element 30 and the light source 20. The light guide may be a rod or a cord and includes, for example, a plastic sheet, PMMA material and/or a polycarbonate material, optical fibers (or bunch of fibers), or silicone material. Providing a light guide inbetween the coupling element 30 and the light source 20 might be necessary in some cases because the size of the electronic circuit may not allow direct coupling from the light source 20 to the coupling element 30.

In a preferred embodiment of the present invention, the light source with its electronic circuit and the light guide in above embodiment are integrated into the casing/housing protecting the said elements. This preferred embodiment enables to fix/attach the casing with the light source and so on to the glazing with coupling element already attached to the second glass pane and also enables the alignment of the light source with the coupling element to be a straight-forward mounting/clipping process, and moreover, it also facilitates the serviceability of the lighting glazing, in case of malfunctioning or any problem, the light source can be replaced without any hurdle.

The coupling element 30 is fixed onto the inner face (P4) of the internal glass pane 12. Preferably, the coupling element 30 is fixed by means of an adhesive layer 22.

The adhesive layer 22 has a refractive index in the range of the refractive index of the coupling element 30 has, or which lies between those of the coupling element 30 and the internal glass pane 12 acting as a light guide. Preferably, the refractive index is comprised between 1.48 and 1.56. As a material for the adhesive layer 22, a pressure-sensitive adhesive, an optically clear liquid adhesive, EVA, PVB, TPU, an epoxy adhesive or an acrylic adhesive may be used.

Through internal reflection at the boundary surfaces of the coupling element 30, the light is coupled via the adhesive layer 22 into the internal glass pane 12, acting as a light guide layer, and it can propagate there via internal reflection at the boundary surfaces.

FIG. 2 is a cross-sectional view for explaining the optical properties of the laminated glass according to the present embodiment. The configuration of the glazing 10 is similar to the example configuration shown in FIG. 1 and in FIG. 2,

Irradiated light A from the light source 20 to the light receiving surface 310 of the coupling element 30 (optical element) propagates inside the coupling element 30 as shown in FIG. 3 and FIG. 4. At this time, the refractive index of air is n1 and the refractive index of the coupling element 30 is n2, and when the light A enters the optical element 30 at the incident angle θ1, the incident light is refracted with an angle of θ1″ (n1*sin(θ1)=n2*sin(θ1″)) and the refracted light propagates with the incident angle θ2 towards to adhesive layer 22. Further, light propagates into the adhesive layer 22 such as optical glue (bonding element), directly or after bouncing on the surface 320, where the surface 320 is the surfaces of the coupling element 30 not subject to (not facing) adhesive layer 22 or the light source 20. At this time the refractive index of the bonding element or adhesive layer 22 is n3 and when the light enters the bonding element at the incident angle θ2, the incident light is refracted with an angle of θ2″ (n2*sin(θ2)=n3*sin(θ2″)) and the refracted light propagates with the incident angle θ3 towards to internal glass pane 12. Further, light propagates into the second glass 12 through the surface P4. At this time the refractive index of the second glass is n4 and when the light enters the second glass at the incident angle θ3, the incident light is refracted with an angle of θ3″ (n3*sin(θ3)=n4*sin(θ3″)) and the refracted light propagates with the incident angle θ4 towards to the interlayer 14. It can easily be seen that the angle θ2 is equal to 90-θ1″, and the angle θ3 is equal to θ2″, and the angle θ4 is equal to θ3″.

In order to stay in TIR (Total internal reflection) inside the second glass pane 12, the incident angle of the light θ4 must be higher or equal to the critical angle θ4c=arcsin(n5/n4), n5 is the refractive index of the interlayer 14. The condition for the total internal reflection is pretty straight forward, and given here for explanation purposes, and shown schematically in FIG. 4. It should be understood that the light decoupling means 13 may not necessarily have its own refractive index, for example in the case of the light decoupling means 13 being surface roughness on the P3 surface of the second glass pane 12, indubitably the light decoupling means 13 may have a refractive index in the case of it being an actual physical layer, and in that case n5 is the refractive index of the light decoupling means 13. The present invention aims to increase the coupling efficiency in a simplified and cost effective manner with the coupling element 30 and therefore, the present invention is not concerned with how the light decoupling means 13 constructed since the coupling element made of glass naturally satisfies the condition for total internal reflection in the second glass pane 12.

The refractive index of the coupling element and the adhesive layer (bonding element) should be selected carefully to maximize the coupling efficiency. In the case of a wrong selection, the worst scenario is no light will propagate in TIR into the second glass pane 12.

Preferably, n2, n3 and n4 should have the same refractive index and this condition can easily be satisfied by the coupling element 30 of the present invention since in the preferred embodiment the coupling element 30 is made from the same mother pane with the second glass pane 12.

The thickness and width of the coupling element 30 should be selected carefully to maximize the coupling efficiency of rays that will be able to stay in TIR in the second glass pane 12, i.e., increasing the width of the coupling element 30 at a certain level results more light from the light source 20 to be coupled to the second glass pane 12.

The thickness should be kept as small as possible knowing that practically it is limited to be the size of the light source 20. Preferably, a thickness equal or lower than 2 times the thickness of the second glass pane 12 can be considered with good efficiency.

The width will be optimized to allow the maximum light to propagate directly towards the second glass pane 12 and to allow a part of the light to bounce on the surface 320 of the coupling element 30 and then to be coupled in TIR into the second glass pane 12.

In the above-mentioned embodiments, low-E coating (low-emissivity layers), as reflective thermal radiation coating, may be provided over the surface of a face of the glazing (P4) and more particular on the glass roof which is turned toward the passenger compartment. Thus, a glazed roof provided with a thermal radiation reflective coating and more particularly a low-E coating provides a best possible compromise between vision outside through the roof and good thermal properties thanks to its long-waves infrared (IR) energy reflection properties.

According to one embodiment of the present invention, the thermal-radiation-reflecting coating can also be referred to as a coating with low emissivity, an emissivity-reducing coating, low-E coating, or low-E layer. Its role is to reflect thermal radiation, i.e., in particular, IR radiation of longer wavelength than the IR component of solar radiation. At low outside temperatures, the low-E coating reflects heat back into the interior and reduces the cooling of the interior. At high outside temperatures, the low-E coating prevents the absorbed thermal radiation of the heated glazing to be re-emitted toward the interior and reduces the heating of the interior. On the interior side of the inner pane, the coating according to the invention reduces the emission of thermal radiation from the pane into the interior particularly effectively in the summer and reduces the transmission of heat into the external environment in the winter.

It is chosen to place the coating in position 4 despite the fact that in this position the layers are not protected from degradation, especially mechanical degradation. It is possible to choose low-E layers that are mechanically and chemically resistant enough.

Advantageously, for good mechanical resistance, the coatings are “hard” layers, such as those produced by PECVD, CVD or pyrolytic techniques. However, low-E systems may also be produced using vacuum cathode sputtering techniques, provided that the systems obtained are composed of layers that are sufficiently resistant.

According to the invention, it is preferred to use a low-emissivity coating system the emissivity of which is lower than 0.3 and preferably lower than 0.2 and in a particularly preferred way lower than 0.1.

The most common pyrolytic low-E (low-emissivity) systems comprise a layer of doped tin oxide deposited on a first layer having the role of neutralizing color in reflection. The layer making contact with the glass is ordinarily a layer of silica or silicon oxycarbide, optionally modified by additives. Tin oxide layers, compared to the layers of systems deposited by cathode sputtering, are relatively thick, i.e. more than 200 nm and in certain cases more than 450 nm in thickness. These thick layers are sufficiently resistant to withstand exposure to mechanical and/or chemical attack.

According to an embodiment, a filtering infrared radiation coating may be provided over the inner face (P2) of the outer glass pane. The coating may be provided over the inner face (P3) of the inner glass pane. The coating comprises one or more metal layers essentially based on silver combined with dielectric layers which, on the one hand, protect the metal layers. An infrared reflective coating may be present within the glazing, typically facing the intermediate PVB layer, such the coating is positioned in P2 or P3. The infrared reflective coating preferably comprises n infrared reflective (IR) layers and n+1 dielectric layers, with n≥1, such that each IR layer is surrounded by two dielectric layers. The IR layers may be made of silver, gold, palladium, platinum or alloys thereof, while the dielectric layers may typically comprise oxides, nitrides, oxynitrides or oxycarbides of Zn, Sn, Ti, Zr, Si, In, Al, Bi, Ta, Hf, Mg, Nb, Y, Ga, Sb, Mg, Cu, Ni, Cr, Fe, V, B or mixtures thereof. The role of the IR reflective coating is to reflect the infrared portions of the solar radiation. Typical infrared reflective coating may be provided by physical vapor deposition, so as to form coatings having a thickness ranging of from 10 to 250 nm.

According to an embodiment, a solution, such as an electrically powered functional film, for modifying the light transmission of the glazing, adjusting tint, privacy, diffusing reflection, for thermal protection, is provided between the outer glass pane and the at least one thermoplastic interlayer the conditions of use have already been proposed. Thus, the glazing may comprise a functional film such as electrochromic means in which the variation is obtained by modifying the state of colored ions in compositions included in these glazings. It is also a question of glazings comprising, in suspension, layers of particles that, depending on the application of an electric voltage, are or are not ordered, such as the systems referred to as suspended particles devices (SPDs), or in a preferred embodiment a polymer-dispersed liquid-crystal (PDLC) film consisting of a polymer containing liquid crystals sensitive to the application of the electric voltage or guest host liquid crystal (GHLC). These functional films allow the light level in the passenger compartment to be modified, their function is also to modify the antiglare effect and the level of privacy. Another role of these films is to protect the interior of the passenger compartment from heat. In particular, these functional films are films that are switchable between a dark state and a translucent or even transparent state.

The glass panes used to form the laminated glazing unit may have the same composition and possibly the same thickness, which may make them easier to shape beforehand, the two sheets being bent simultaneously for example. Most often the glass sheets have different compositions and/or thicknesses, and in this case they may be shaped separately.

The possible presence of colored interlayers participates in the absorption of light. Their use may be envisioned as a partial substitute at least to the contribution of the glass sheets to establishing a particular color. This situation may arise, for example, when, in order to integrate photovoltaic elements into the glazing unit, at least the external glass sheet is a sheet of poorly absorbent glass or even extra-clear glass. However, the external sheet may also be a sheet of absorbent glass, and there is no need for a colored interlayer. Thus according to one embodiment of the present invention, the light source or a functional film powered electrically may be powered thanks to the photovoltaic cells. The energy produced by the photovoltaic cells may be used also to power some other elements of the vehicle.

The internal glass pane turned toward the passenger compartment may also, be made of clear glass and more preferably of extra-clear glass. It is most often absorbent and contributes to the overall decrease in energy transmission. When its transmission is limited, it allows non-transparent elements present in the glazing unit to be at least partially masked from the sight of passengers. The internal glass pane may have structuring of its outer surface (P3) of the internal glass pane. The structuring is produced mechanically, for example, by imprinting the structure into the surface, for example. Alternatively, the structuring can be caused by printing, in particular using a pad print, so that the printed material represents the scattering structures. A further possibility for the structuring of the surface of the layer consists of etching of the surface, by which the surface is roughened to generate the scattering effect. Furthermore, the roughening or structuring can also be achieved by a blasting method, for example, by sandblasting.

The present invention provides a simplified and cost effective solution to the coupling problem to the lighting vehicle glazings by providing the coupling element made of glass material and preferably same material with the second glass pane. With the present invention, the production of such lighting glazing is simplified without compromising the performance, i.e., the coupling efficiency. In addition, the production time is reduced drastically since the coupling element requires no extra process to be produced compared to wedged-shaped coupling prisms known in the art since the coupling element of the present invention is a regularly shaped flat glass.

Combinations of the described embodiments are included by the invention.

For avoidance of doubt, the present invention is applicable for all means of transport such as automotive vehicle, vans, lorries, motorbikes, buses, trams, trains, airplanes, helicopters and the like . . . . According to an embodiment of the present invention, the glazing may be a glazed roof, a sidelite, a backlite or a part of windshield of an automotive vehicle. The glazing may be also an external applique.

### REFERENCE LIST

10 vehicle roof
11 external glass pane
12 internal glass pane
13 light-decoupling layer
14 interlayer
20 light source
30 coupling element
310 side edge of the coupling element
320 surface of the coupling element
22 adhesive layer
25 masking band

1. A lighting vehicle glazing comprising:
an external glass pane having an outer surface and an inner surface and
an internal glass pane having an outer surface and an inner surface, acting as a light guide layer
the external and the internal glass panes laminated together via at least a first plastic interlayer,
a light-decoupling means provided between the first plastic interlayer and the internal glass pane,
a masking band provided along a periphery of the inner surface of the external glass pane and/or the inner surface of the internal glass pane,
a light source provided on the masking band or in a vicinity of the masking band, the light source being placed on the inner surface of the inner glass pane,
at least one coupling element provided in a vicinity of the light source, in a free zone of the masking band, and materially bonded to the internal glass pane on its inner surface, that couples light emitted from the light source into the internal glass pane, the light source facing a side edge of the coupling element;
wherein the coupling element is made of glass material.

2. The lighting vehicle glazing according to claim 1, wherein the coupling element (30) has a parallelepiped shape.

3. The lighting vehicle glazing according to claim 1, wherein the coupling element has a rectangular-like shape.

4. The lighting vehicle glazing according to claim 1, wherein the coupling element has a refractive index equal or higher than a refractive index of the internal glass pane.

5. The lighting vehicle glazing according to claim 6, wherein the adhesive layer which has a refractive index of between 1.40 and 1.65.

6. The lighting vehicle glazing according to claim 1, wherein the coupling element is attached to the inner surface of the inner glass pane via an adhesive layer.

7. The lighting vehicle glazing according to claim 1, wherein the light source is an LED strip.

8. The lighting vehicle glazing according to claim 1, wherein the coupling element has a glass composition similar to a glass composition of the internal glass pane.

9. The lighting vehicle glazing according to claim 1, wherein the light-decoupling means is a light-conducting plastic interlayer.

10. The lighting vehicle glazing according to claim 1, wherein the light-decoupling means is a textured surface of the internal glass pane.

11. The lighting vehicle glazing according to claim 1, wherein the glazing is glazed roof.

12. (canceled)

13. (canceled)

14. a The lighting vehicle glazing according to claim 1, wherein the coupling element is made of glass.

15. The lighting vehicle glazing according to claim 5, wherein the adhesive layer has a refractive index of between 1.48 and 1.56.
